(19) United States
(12) Patent Application Publication
(10) Pub. No.: US 2026/0039241 A1
(43) Pub. Date: Feb. 5, 2026

(54) SOLAR TRACKER SYSTEM WITH TOOLLESS FASTENING RAIL ASSEMBLIES

(71) Applicant: Nextracker LLC, Fremont, CA (US)

(72) Inventors: Venkata Nitin Mythreya Yadlapalli, Nellore (IN); Bhanu Rekha Bandhakavi, Hyderabad (IN); Ashutosh Animesh, Hyderabad (IN)

(21) Appl. No.: 19/288,061

(22) Filed: Aug. 1, 2025

Related U.S. Application Data
(60) Provisional application No. 63/678,867, filed on Aug. 2, 2024.

(51) Int. Cl. H02S 20/32

(52) U.S. Cl. CPC H02S 20/32

(57) ABSTRACT

A toolless fastening assembly for a solar power system including a first strap portion having a first connector, a second strap portion having a second connector, and a boot buckle extending a buckle distance between a first buckle end and a second buckle end. The first buckle end is connectable to the first connector and the second buckle end is connectable to the second connector. The boot buckle includes a latch lever that is rotatable between a first lever position and a second lever position. Rotation of the latch lever from the first lever position to the second lever position shortens the buckle distance.

### RELATED APPLICATIONS

This application claims the benefit of U.S. Provisional Patent Application No. 63/678,867, filed Aug. 2, 2024, the entire contents of which are incorporated herein by reference.

### TECHNICAL FIELD

This disclosure relates generally to solar power generation systems, and more particularly, to toolless fastening mechanisms for solar arrays within a solar tracking system.

### BACKGROUND

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds to thousands of individual solar modules that are mechanically coupled to support structures.

Coupling the numerous solar modules to the support structure requires a significant number of clamps or other mechanisms, each requiring a significant number of fasteners, driving up the cost of manufacturing each mechanism. As can be appreciated, assembling each of these mechanisms and securely tightening each fastener requires an enormous amount of time, contributing to increased cost and longer assembly time.

In view of these costly processes and designs, fastening mechanisms that alleviate the need for costly and time-consuming processes, and reduce the amount of material and labor required for installation are needed.

### SUMMARY

In general, the present disclosure relates to support structures for solar arrays within a solar tracking system. In a first example, a toolless fastening assembly for a solar power system may include a first strap portion having an elongate body and having a first connector, a second strap portion having an elongate body and having a second connector, and a boot buckle extending a buckle distance between a first buckle end and a second buckle end, the first buckle end being connectable to the first connector and the second buckle end being connectable to the second connector. The boot buckle may include a latch lever, the latch lever rotatable between a first lever position and a second lever position, rotation of the latch lever from the first lever position to the second lever position shortening the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance.

Additionally or alternatively, the first strap portion and the second strap portion may be connected to form a strap, the strap extending between the first connector and the second connector.

Additionally or alternatively, the strap may have a circular portion and a mounting portion, the circular portion for engagement with a support beam, the mounting portion extending away from the support beam and forming a surface on which solar modules may be mounted.

Additionally or alternatively, the boot buckle may have a first band and a second band, the first band being rotatably coupled to the latch lever and extending towards the first buckle end, and the second band being rotatably coupled to the latch lever and extending towards the second buckle end.

Additionally or alternatively, rotation of the latch lever from the first lever position to the second lever position, may pull the rotatable coupling of the first band towards the second buckle end, and pulls the rotatable coupling of the second band towards the first buckle end.

Additionally or alternatively, the first strap portion may include a first stop configured to pass through a first slot in a strap guide portion of the rail, and the second strap portion may include a second stop configured to pass through a second slot in the strap guide portion of the rail.

Additionally or alternatively, the first strap portion and the second strap portion may be formed from steel.

Additionally or alternatively, the strap may include a circular profile.

Additionally or alternatively, the first connector and the second connector may form a gap therebetween to permit a portion of the support beam to pass therethrough.

In another example, a solar tracker may include a support beam, a rail, and a toolless fastening assembly configured to couple the rail to the support beam. The toolless fastening assembly may include a first strap portion having an elongate body and having a first connector, a second strap portion having an elongate body and having a second connector, and a boot buckle extending a buckle distance between a first buckle end and a second buckle end. The first buckle end being connectable to the first connector and the second buckle end being connectable to the second connector. The boot buckle having a latch lever, the latch lever rotatable between a first lever position and a second lever position, rotation of the latch lever from the first lever position to the second lever position shortening the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance. The solar tracker may also include a solar module coupled to the rail.

Additionally or alternatively, the first strap portion and the second strap portion may be connected to form a strap, the strap extending between the first connector and the second connector.

Additionally or alternatively, the strap may have a circular portion and a mounting portion, the circular portion for engagement with a support beam, the mounting portion extending away from the support beam and forming a surface on which solar modules may be mounted.

Additionally or alternatively, the boot buckle has a first band and a second band, the first band being rotatably coupled to the latch lever and extending towards the first buckle end, and the second band being rotatably coupled to the latch lever and extending towards the second buckle end.

Additionally or alternatively, rotation of the latch lever from the first lever position to the second lever position, pulls the rotatable coupling of the first band towards the second buckle end, and pulls the rotatable coupling of the second band towards the first buckle end.

Additionally or alternatively, the strap includes a circular profile.

Additionally or alternatively, the first connector and the second connector form a gap therebetween to permit a portion of the support beam to pass therethrough.

In another example, a method of coupling a solar module to a support beam may include attaching a rail to the support beam via a toolless fastening assembly. The toolless fastening assembly may include a first strap portion having an elongate body and having a first connector, a second strap portion having an elongate body and having a second connector, and a boot buckle extending a buckle distance between a first buckle end and a second buckle end. The first buckle end being connectable to the first connector and the second buckle end being connectable to the second connector. The boot buckle may include a latch lever, and the latch lever may be rotatable between a first lever position and a second lever position. Rotation of the latch lever from the first lever position to the second lever position may shorten the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance, and coupling the solar module to the rail.

Additionally or alternatively, the boot buckle has a first band and a second band, the first band being rotatably coupled to the latch lever and extending towards the first buckle end, and the second band being rotatably coupled to the latch lever and extending towards the second buckle end.

Additionally or alternatively, rotating the latch lever from the first lever position to the second lever position, wherein the rotation pulls the rotatable coupling of the first band towards the second buckle end, and pulls the rotatable coupling of the second band towards the first buckle end.

Additionally or alternatively, aligning a dimple of the rail with a bore of the support beam such that the dimple is held within the bore when the latch lever is rotated from the first lever position to the second lever position.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a bottom view of a portion of the solar tracker as in FIG. 1;

FIG. 4A is a perspective view of a toolless fastening assembly in accordance with the present disclosure;

FIG. 4B is a perspective view of the toolless fastening assembly and a guide portion in accordance with the present disclosure;

FIG. 5A is a perspective view of a toolless fastening assembly, as in FIGS. 4A to 4B, coupled to a support beam;

FIG. 5B is a bottom perspective view of the toolless fastening assembly, as in FIGS. 4A to 4B, coupled to a support beam;

FIG. 5C is a front view of the toolless fastening assembly, as in FIGS. 4A to 4B, coupled to the support beam;

FIG. 6A is a perspective view of the toolless fastening assembly as in FIG. 5A with the support beam removed;

FIG. 6B is a is a bottom perspective view of the toolless fastening assembly as in FIG. 5B with the support beam removed;

FIG. 7A is a bottom perspective view of the toolless fastening assembly as in FIG. 4A in a first position;

FIG. 7B is a bottom perspective view of the toolless fastening assembly as in FIG. 4A in a second position;

FIG. 8A is a perspective view of a toolless fastening assembly in accordance with the present disclosure in a first position;

FIG. 8B is a perspective view of the toolless fastening assembly as in FIG. 7A, in a second position;

FIG. 9A is a top perspective view of a toolless fastening assembly coupled to a support beam, as in FIG. 8A;

FIG. 9B is a top perspective view of the toolless fastening assembly as in FIG. 8A, with the support beam removed; and

FIG. 10 is a front view of a toolless fastening assembly in accordance with the present disclosure.

### DETAILED DESCRIPTION

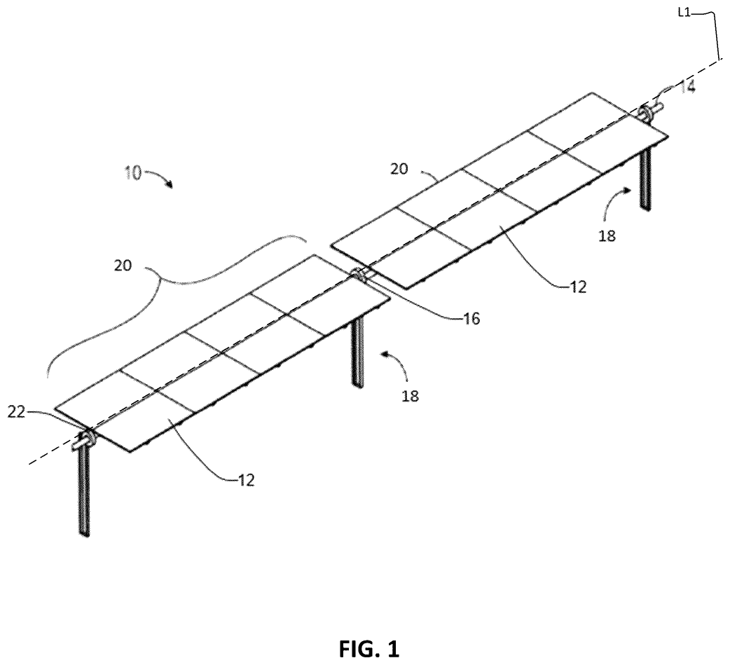

The present disclosure is directed to a toolless fastening assembly for a solar power system, generally referred to herein as a solar tracker. FIG. 1 is an elevation view of a common arrangement of a solar tracker assembly 10 provided in accordance with the present disclosure. In some applications, a plurality of solar tracker assemblies 10 may be arranged in a north-south longitudinal orientation to form rows of a solar array. The solar tracker assembly 10 may be formed of a plurality of bays 20 defined by the distance between each foundation of a plurality of foundations 18 arranged in a row. The plurality of foundations 18 (generally referenced herein as foundations 18) may be disposed in spaced relation to one another and partially embedded in the earth. In some examples, the foundations 18 may be multi-component tubular support members, or A-frame supports, and/or may be configured to couple to A-frame supports. The foundations 18 may have one or more embedment in the ground, such as one for each leg of an A-frame support where the embedments are spaced apart in the east-west direction. FIG. 1 illustrates two bays 20 of the solar tracker assembly 10. However, it will be appreciated that the solar tracker assembly 10 may include four bays, six bays, ten bays, twenty bays, or any other suitable number of bays as desired. At each foundation 18 is either a bearing 22 or generally near the center of the solar tracker assembly 10 a drive mechanism 16. Each of the bearings 22 and the drive mechanism 16 are supported by one of the foundations 18. Activation of the drive mechanism rotates at least one support beam 14 about an axis of rotation and thus rotates a plurality of solar module assemblies 12 mounted to the at least one support beam 14 such that the plurality of solar module assemblies 12 can be oriented to a desired position. In some examples, the at least one support beam 14 may extend along the row of the solar array, defining a central longitudinal axis Li extending therethrough, the at least one support beam 14 may be pivotally mounted to the foundations 18, the pivotal mounting permitting the at least one support beam 14 to rotate about an axis of rotation parallel to the row of the solar array. In some examples, the at least one support beam 14 may comprise a torque tube, or two or more support beams configured to support the plurality of solar module assemblies 12. The desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker assembly 10 is located given the current weather and atmospheric conditions, the current demands of the grid, and other factors. The bearings 22 reduce to the extent possible the resistance to movement of the support beam 14 and the plurality of solar module assemblies 12.

In some examples, when the at least one support beam 14 is a torque tube, the support beam may be sized (e.g., diameter, wall thickness, material) such that sag between the foundations 18 is reduced or substantially eliminated and to absorb torsional loads applied to the support beam by wind loading. In addition, since there is often just a single drive mechanism 16, the specifications for the support beam may desire to eliminate twist of the support beam along its length. Any twist would result in the plurality of solar module assemblies 12 being oriented differently from what is desired, and thus again reduce the output and efficiency of the solar tracker assembly 10, particularly, as the solar tracker assembly 10 is rotated to the extreme angles of permitted range (e.g., +/−75 degrees or more), for example, during stowing.

As will be appreciated, each of the plurality of solar module assemblies 12 must be supported on the at least one support beam 14. This is typically achieved by a bracket system (not shown in FIG. 1) that is attached to the at least one support beam 14 substantially perpendicular to the central longitudinal axis Li of the at least one support beam 14. The at least one support beam 14 may be rotatable about its central longitudinal axis Li to adjust an angular orientation of the plurality of solar module assemblies 12 relative to the sun, while supporting the plurality of solar module assemblies 12 on the bracket system. The bracket system may take many forms including two pieces of shaped steel, which may be arranged to sandwich the plurality of solar module assemblies 12, and may be configured to connect to a rail, which is then coupled to the at least one support beam 14.

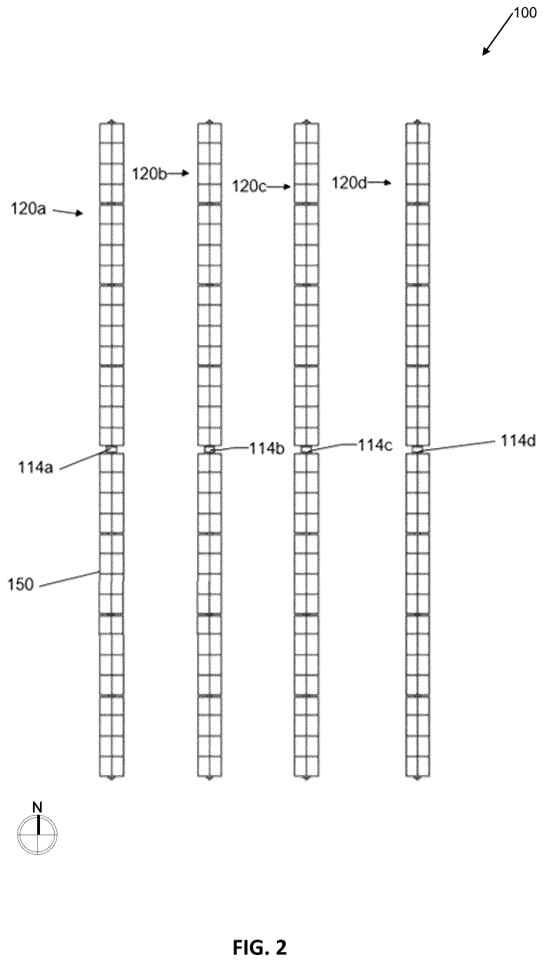

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on at least one support beam 114a, 114b, 114c, 114d (generally referred to herein as support beam 114), which in turn is supported by a plurality of support piers (not explicitly shown in FIG. 2). The support beam 114 may be an example of the support beam 14, as in FIG. 1. As shown, the solar tracker rows 120 may be separated by a space sufficient to allow machinery to travel therethrough to allow for cleaning and maintenance

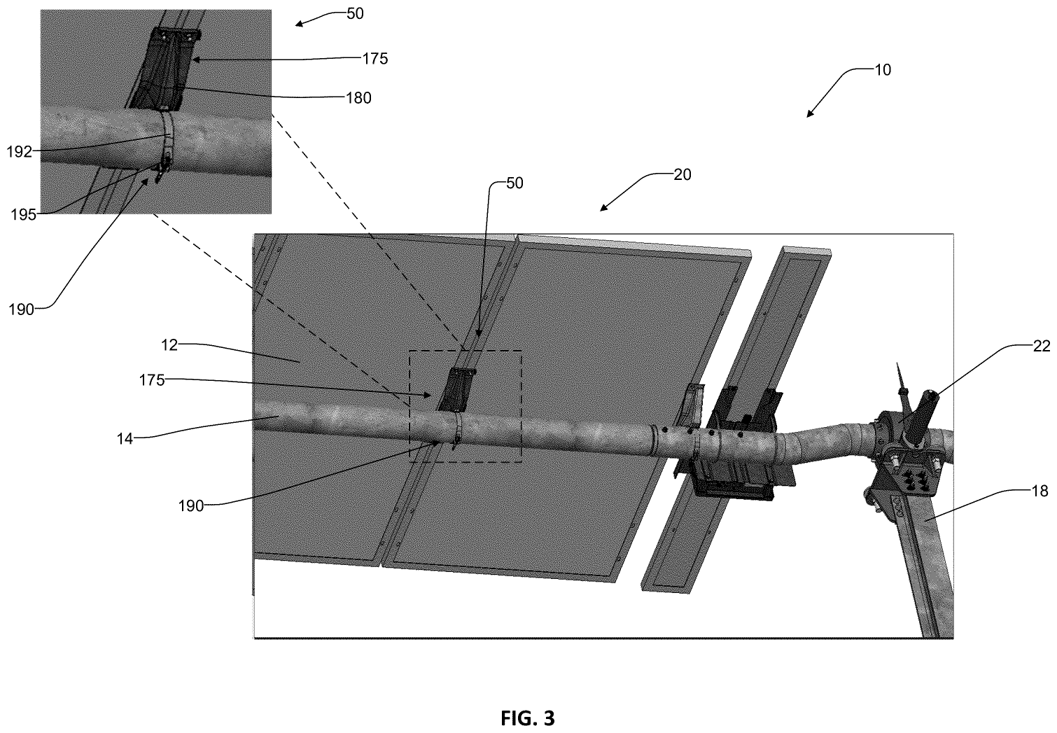

FIG. 3 is a bottom view of a portion of the solar tracker 10. The solar tracker 10 may include a toolless fastening assembly 175 which may include a rail 180 and a strap assembly 190. The rail 180 is configured to be secured to the support beam 14 via the strap assembly 190. In this manner, the strap assembly 190 is operatively coupled to the rail 180 and includes a strap 192 that is configured to be clamped or secured to the support beam 14 via a boot buckle 195, as shown in box 50. In some embodiments, the solar tracker 10 may include multiple toolless fastening assemblies 175 positioned along the support beam 14 configured to secure multiple solar modules 12 to the support beam 14.

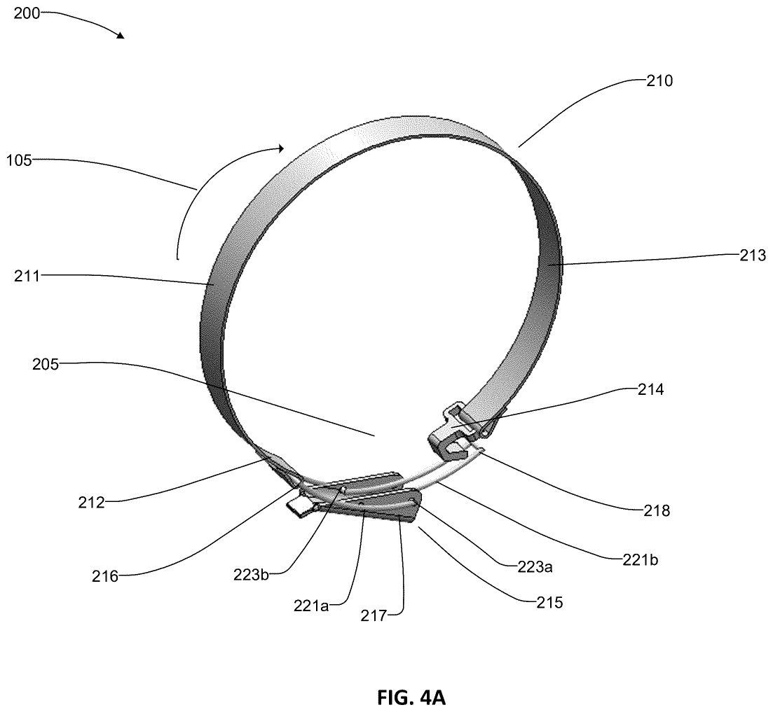

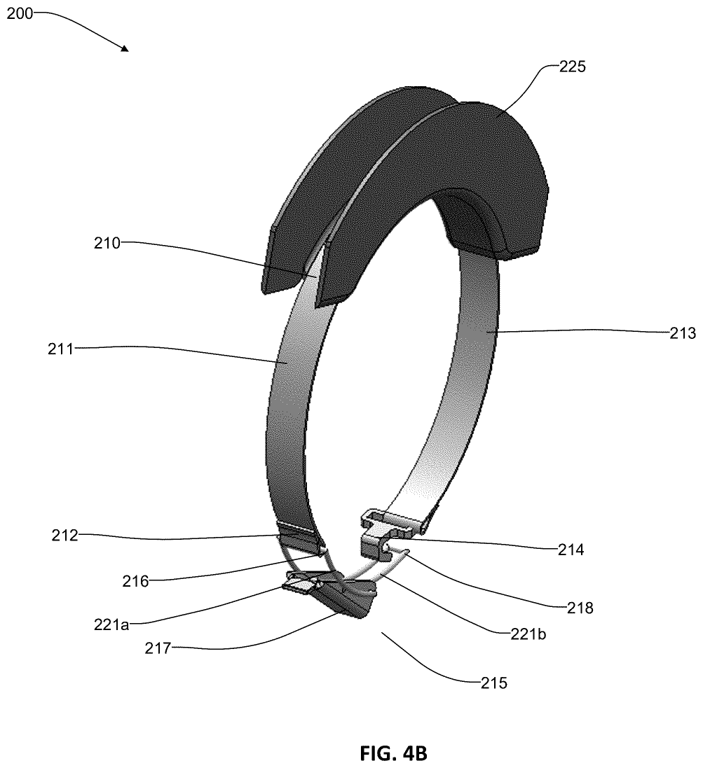

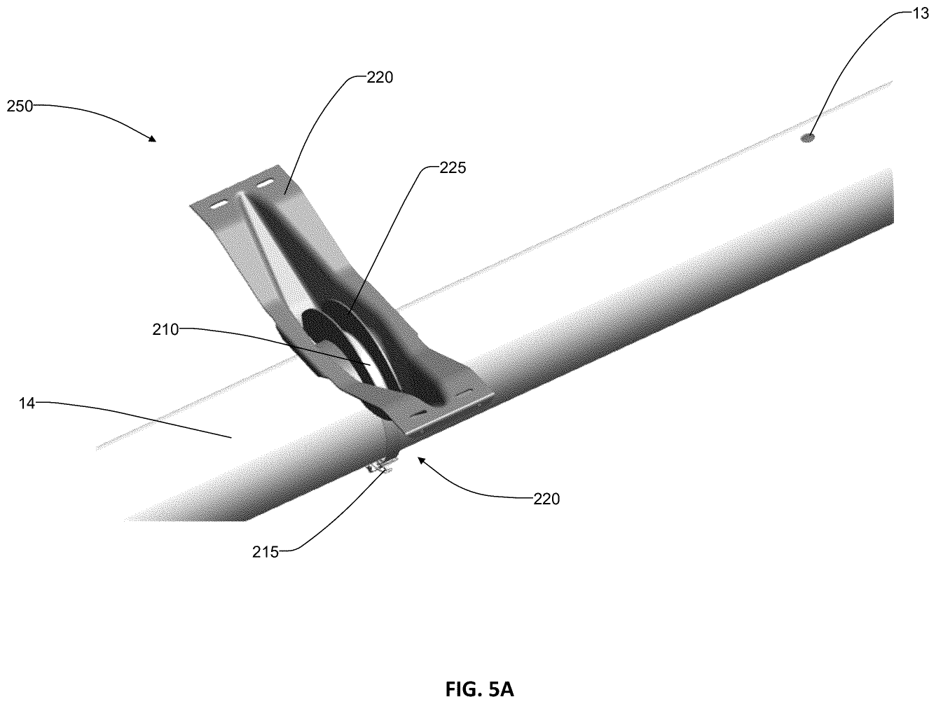

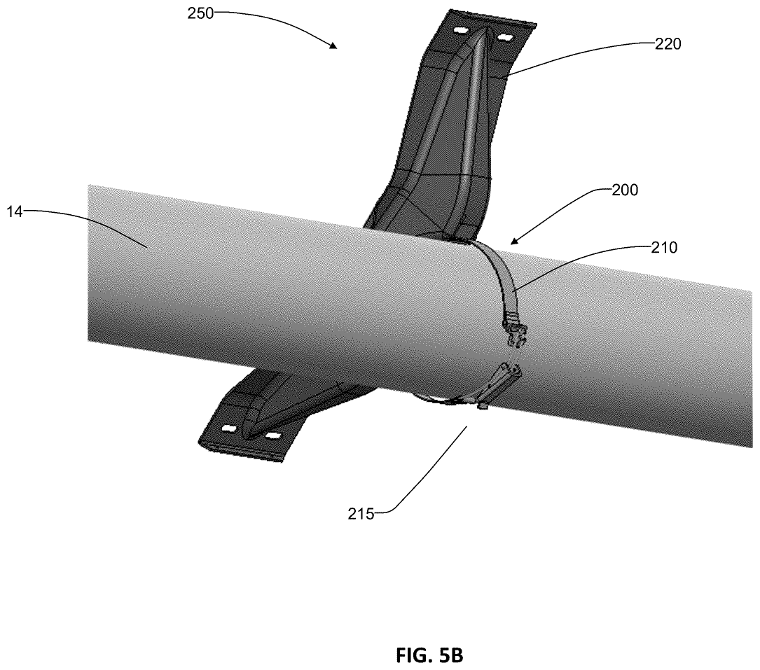

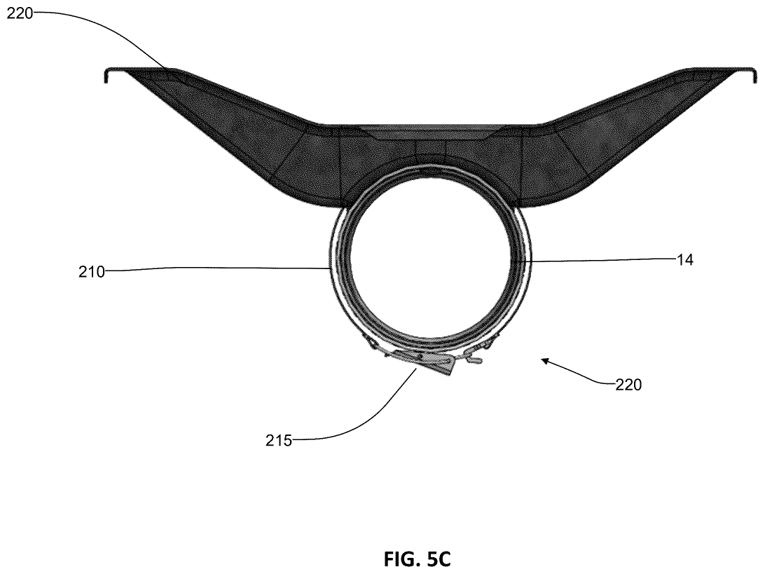

FIG. 4A is a perspective view of a strap assembly 200 in accordance with the present disclosure, and FIG. 4B is a perspective view of the strap assembly 200 and a guide portion 225. The strap assembly 200 is like the strap assembly 190 as shown in FIG. 3 and may be part of a toolless fastening assembly 250 (shown in FIGS. 5A to 7B) for a solar power system, e.g., solar tracker 10. The strap assembly 200 may include a first strap portion 211 having an elongate body and having a first connector 212, a second strap portion 213 having an elongate body and having a second connector 214, and a boot buckle 215. In some embodiments, the first strap portion 211 and the second strap portion 213 may be connected to form a strap 210. The strap 210 may be configured to fit within the guide portion 225 to maintain placement of the strap 210 within the rail 220, however this isn't always necessary. The strap 210 may extend between the first connector 212 and the second connector 214. While the strap 210 may extend in a first direction (as indicated by arrow 105) and connect from the first connector 212 to the second connector 214, the first connector 212 and the second connector 214 may form a gap 205 therebetween to permit a portion of the support beam 14 to pass therethrough, as shown in FIGS. 5A and 5B. In some embodiments, the strap 210 may include a generally circular profile so as to form a tight fit around the support beam 14. In some embodiments, the strap 210 and/or the support beam 14 may include a square profile, an oval profile, a hexagonal profile, or any other suitable profile, and the strap 210 and support beam 14 may have the same or different profile. In some embodiments, the strap 210 may be formed from steel, aluminum, titanium, titanium alloys, composite materials, or the like.

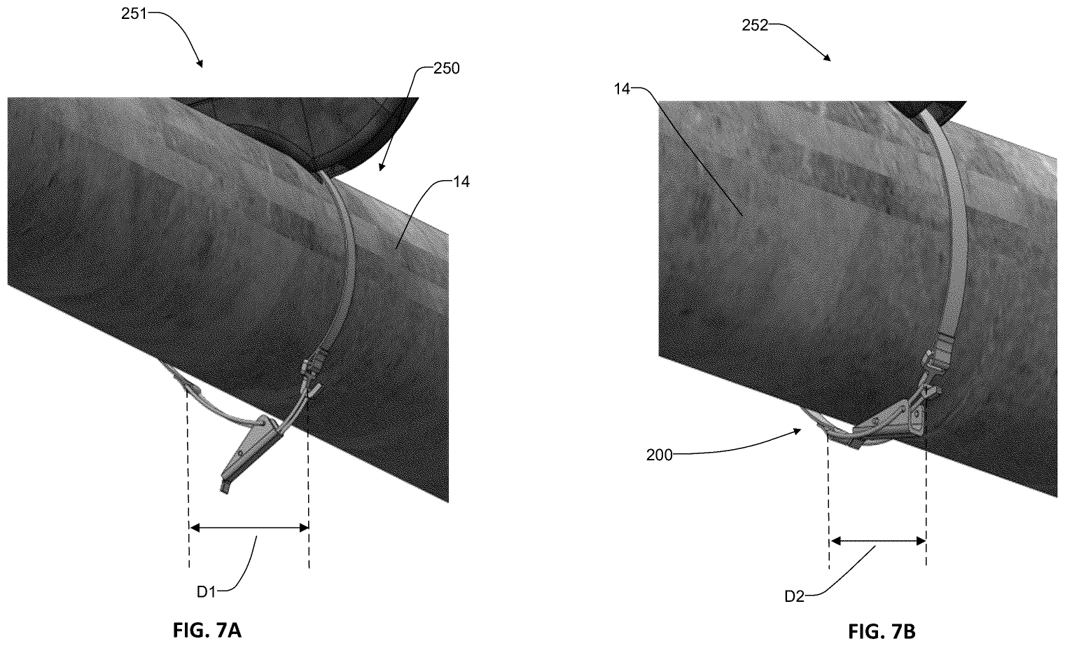

The boot buckle 215 may be positioned in the gap 205 and may include a first buckle end 216 and a second buckle end 218 extending a buckle distance D₁ therebetween, as shown in FIG. 7A. The first buckle end 216 may be connectable to the first connector 212, and the second buckle end 218 may be connectable to the second connector 214. The boot buckle 215 may further include a latch lever 217. The latch lever 217 may be rotatable between a first lever position and a second lever position, as shown in FIGS. 7A and 7B. The boot buckle may include a first band 221a and a second band 221b. The first band 221a may be rotatably coupled to the latch lever 217 and may extend from a first pivot point 223a towards the first buckle end 216, and the second band 221b may be rotatably coupled to the latch lever 217 and may extend from a second pivot point 223b towards the second buckle end 218.

The first connector 212 may be formed as an eye or a loop configured to receive and hold the first buckle end 216 of the boot buckle 215. In some cases, the first connector 212 may include a hook, although this is not explicitly shown. In some embodiments, the second connector 214 may include a hook configured to receive and hold the second buckle end 218 of the boot buckle 215. In some cases, the second connector 214 may include an eye or a loop, although this is not explicitly shown. In some cases, the first connector 212 and the second connector 214 may each include a hook and the boot buckle 215 may be coupled to the first connector 212 and the second connector 214 after the strap 210 is positioned around the support beam 14. It may be contemplated that the first connector 212 and the second connector 214 may include a boss, an eye hook, a clevis hook, a sling hook, a latch, a nut and bolt assembly, or any other suitable type of connector.

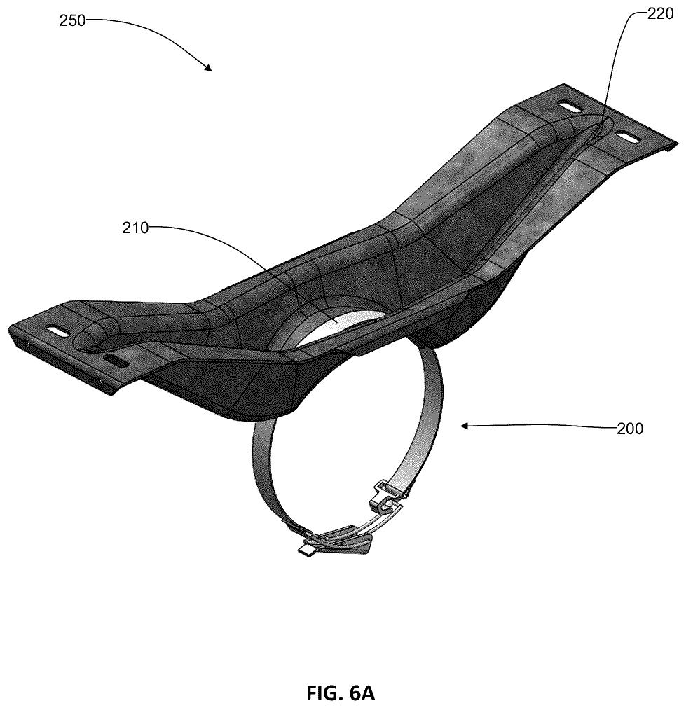

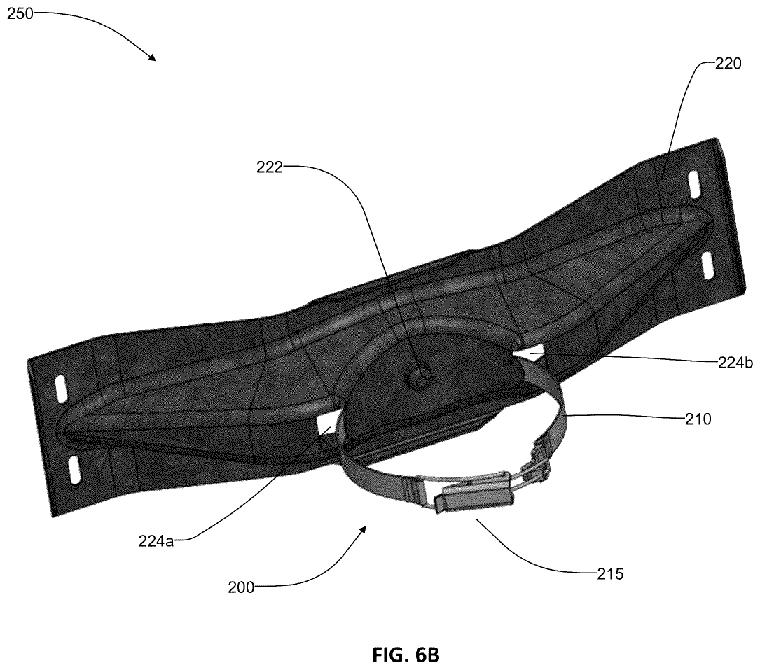

FIG. 5A is a perspective view of the toolless fastening assembly 250 including a rail 220 coupled to the support beam 14 using the strap assembly 200, FIG. 5B is a bottom perspective view of the toolless fastening assembly 250 coupled to the support beam 14, and FIG. 5C is a front view of the toolless fastening assembly 250 coupled to the support beam 14. FIG. 6A is a perspective view of the toolless fastening assembly 250 with the support beam 14 removed, and FIG. 6B is a bottom perspective view of the toolless fastening assembly 250 with the support beam 14 removed. As shown in FIGS. 5A and 5B, the toolless fastening assembly 250 is positioned such that the support beam 14 is received within the strap 210 between the rail 220 and the boot buckle 215.

As shown in FIG. 6B, the rail 220 may include one or more slots 224a, 224b defined therein for receipt of a portion of the strap 210. Further, the rail 220 may include a dimple 222 that may be configured to be positioned within a hole or a bore 13, as shown in FIG. 5A on the support beam 14. The engagement of the dimple 222 with the bore 13 serves to hold the rail 220 relative to the support beam 14 to prevent inadvertent movement of the rail 220 relative to the support beam 14. In other words, the rail 220 will rotate with the support beam 14 when the support beam 14 moves, but the rail 220 will not move independent of the support beam 14.

FIG. 7A is a bottom perspective view of the strap assembly 200 with the boot buckle 215 in a first lever position 251, and FIG. 7B is a bottom perspective view of the strap assembly 200 with the boot buckle 215 in a second lever position 252. Rotation of the latch lever 217 from the first lever position 251 to the second lever position 252 may shorten the buckle distance, as indicated by D₂ in FIG. 7B. For example, in use, an installer may rotate the latch lever 217 from the first lever position 251, shown in FIG. 7A, to the second lever position 252, shown in FIG. 7B, when the first buckle end 216 is connected to the first connector 212 and the second buckle end 218 is connected to the second connector 214, which thereby pulls the first buckle end 216 closer to the second buckle end 218 to shorten the buckle distance (e.g., D₂). This tightens the strap 210 around the support beam 14, holding the dimple 222 within a bore of the support beam 14, effectively coupling the rail 220 to the support beam 14.

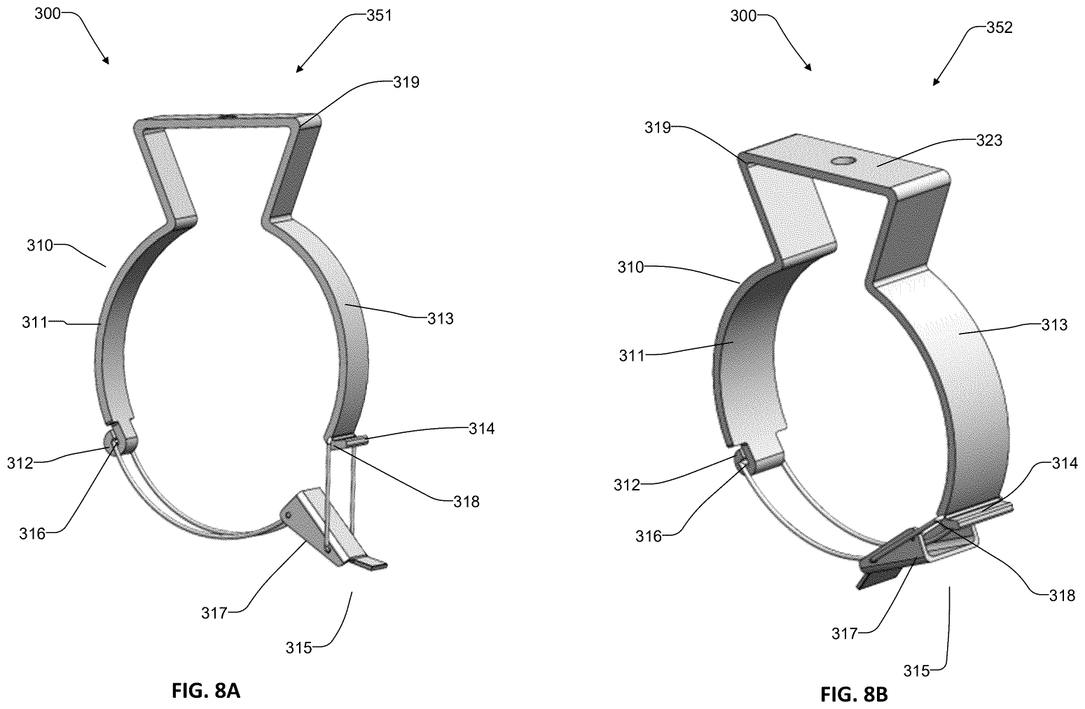

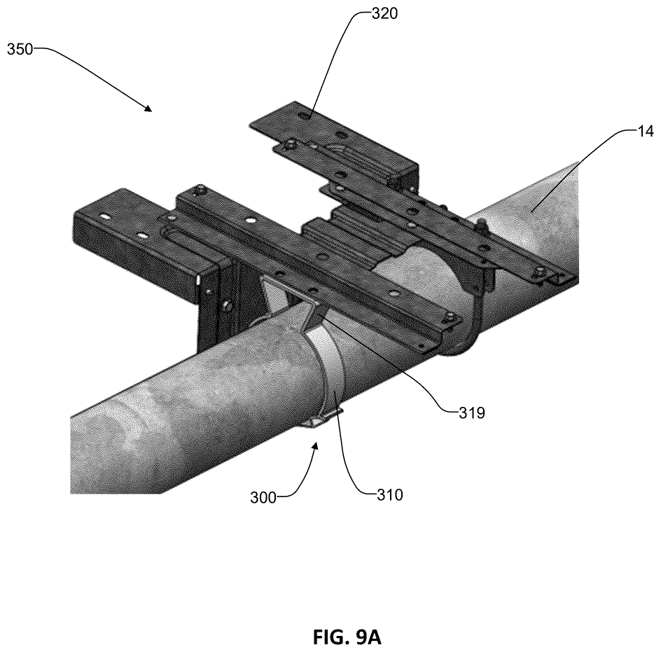

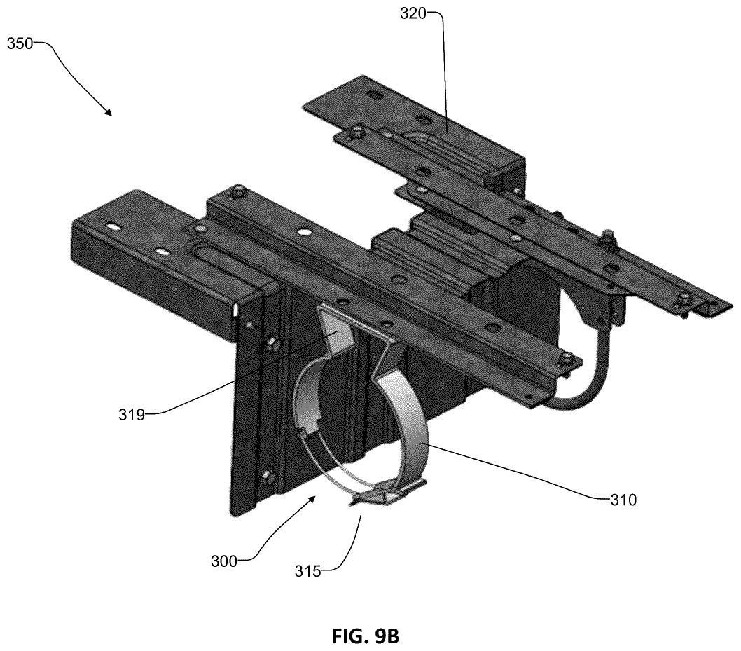

FIG. 8A is a perspective view of a strap assembly 300 in accordance with the present disclosure in a first lever position 351 and FIG. 8B is a perspective view of the strap assembly 300 in a second lever position 352. The strap assembly 300 is like the strap assembly 200, except that the strap assembly 300 includes a circular portion 310 and a mounting portion 319. The circular portion 310 may be configured for engagement with the support beam 14, as shown in FIG. 9A. The mounting portion 319 may extend away from the support beam 14 and may form a surface 323 on which solar modules (e.g., solar module 12) may be mounted. Rotation of the latch lever 317 from the first lever position 351 to the second lever position 352 may shorten the buckle distance, as shown in FIG. 8B. For example, in use, an installer may rotate the latch lever 317 from the first lever position 351, shown in FIG. 8A, to the second lever position 352, shown in FIG. 8B, when the first buckle end 316 is connected to the first connector 312 and the second buckle end 318 is connected to the second connector 314, which thereby pulls the first buckle end 316 closer to the second buckle end 318 to shorten the buckle distance. This tightens the strap assembly 300 around the support beam 14.

FIG. 9A is a top perspective view of a toolless fastening assembly 350 coupled to the support beam 14, and FIG. 9B is a top perspective view of the toolless fastening assembly 350 with the support beam 14 removed. The toolless fastening assembly 350 is like the toolless fastening assembly 350 except for the rail is a panel mount 320 rather than the saddle rail 220.

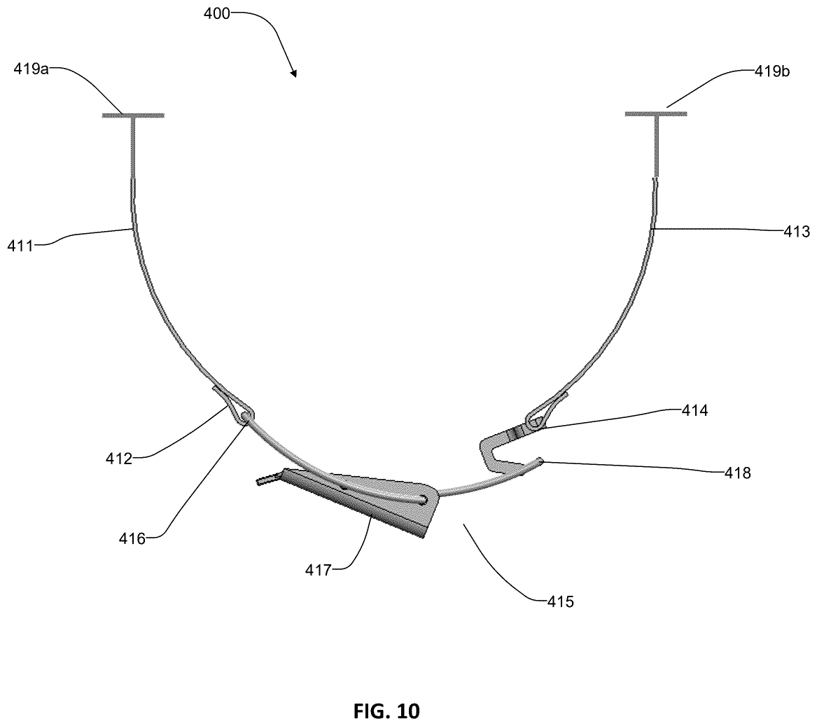

FIG. 10 is a front view of a strap assembly 400 in accordance with the present disclosure. As shown in FIG. 10, the strap assembly 400 may include a first strap portion 411 having a first stop 419a and a second strap portion 413 having a second stop 419b. The first stop 419a may be configured to pass through a first slot in the rail (e.g., rail 220), and the second stop 419b may be configured to pass through a second slot in the rail (e.g., rail 220). As shown in FIG. 6B, the rail 220 may include one or more slots 224a, 224b defined therein for receipt of a portion of the strap assembly 400. For example, the first stop 419a may be configured to pass through and be received within a first slot 224a and the second stop 419b may be configured to pass through and be received within a second slot 224b. In this manner, as the support beam 14 is received within strap assembly 400, the support beam 14 is retained between the rail 220 and strap 410 via the first stop 419a and the second stop 419b.

Various non-limiting exemplary embodiments have been described. It will be appreciated that suitable alternatives are possible without departing from the scope of the examples described herein.

1. A solar tracker assembly comprising:
a plurality of foundations arranged in a row;
at least one support beam extending along the row, defining a central longitudinal axis extending therethrough, and pivotally mounted to the plurality of foundations, the pivotal mounting permitting the at least one support beam to rotate about an axis of rotation parallel to the row;
a plurality of solar module assemblies being coupled to and rotated by the at least one support beam, the rotation of the plurality of solar modules orienting the modules about the axis of rotation; and
a plurality of rails coupling the plurality of solar module assemblies to the at least one support beam, the plurality of rails being distributed at different longitudinal locations along the central longitudinal axis, each solar module assembly mounted to a respective one of the rails;
each of the plurality of rails coupled to the at least one support beam via a toolless fastening assembly, the toolless fastening assembly comprising:
a first strap portion having an elongate body and having a first connector;
a second strap portion having an elongate body and having a second connector; and
a boot buckle extending a buckle distance between a first buckle end and a second buckle end, the first buckle end being connectable to the first connector and the second buckle end being connectable to the second connector, the boot buckle having a latch lever, the latch lever rotatable between a first lever position and a second lever position, rotation of the latch lever from the first lever position to the second lever position shortening the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance.

2. The solar tracker assembly of claim 1, wherein the first strap portion and the second strap portion are connected to form a strap, the strap extending between the first connector and the second connector.

3. The solar tracker assembly of claim 2, wherein the strap has a circular portion and a mounting portion, the circular portion for engagement with the at least one support beam, the mounting portion extending away from the at least one support beam and forming a surface on which solar modules may be mounted.

4. The solar tracker assembly of claim 1, wherein the boot buckle has a first band and a second band, the first band being rotatably coupled to the latch lever and extending towards the first buckle end, and the second band being rotatably coupled to the latch lever and extending towards the second buckle end.

5. The solar tracker assembly of claim 4, wherein, rotation of the latch lever from the first lever position to the second lever position, pulls the rotatable coupling of the first band towards the second buckle end, and pulls the rotatable coupling of the second band towards the first buckle end.

6. The solar tracker assembly of claim 1, wherein the first strap portion includes a first stop configured to pass through a first slot in a strap guide portion of the rail, and the second strap portion includes a second stop configured to pass through a second slot in the strap guide portion of the rail.

7. The solar tracker assembly of claim 1, wherein the first strap portion and the second strap portion are formed from steel.

8. The solar tracker assembly of claim 2, wherein the strap includes a circular profile.

9. The solar tracker assembly of claim 2, wherein the first connector and the second connector form a gap therebetween to permit a portion of the support beam to pass therethrough.

10. A solar tracker comprising:
a support beam;
a rail;
a toolless fastening assembly configured to couple the rail to the support beam, the toolless fastening assembly comprising:
a first strap portion having an elongate body and having a first connector,
a second strap portion having an elongate body and having a second connector, and
a boot buckle extending a buckle distance between a first buckle end and a second buckle end, the first buckle end being connectable to the first connector and the second buckle end being connectable to the second connector, the boot buckle having a latch lever, the latch lever rotatable between a first lever position and a second lever position, rotation of the latch lever from the first lever position to the second lever position shortening the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance; and
a solar module coupled to the rail.

11. The solar tracker of claim 10, wherein the first strap portion and the second strap portion are connected to form a strap, the strap extending between the first connector and the second connector.

12. The solar tracker of claim 11, wherein the strap has a circular portion and a mounting portion, the circular portion for engagement with the support beam, the mounting portion extending away from the support beam and forming a surface on which solar modules may be mounted.

13. The solar tracker of claim 10, wherein the boot buckle has a first band and a second band, the first band being rotatably coupled to the latch lever and extending towards the first buckle end, and the second band being rotatably coupled to the latch lever and extending towards the second buckle end.

14. The solar tracker of claim 13, wherein, rotation of the latch lever from the first lever position to the second lever position, pulls the rotatable coupling of the first band towards the second buckle end, and pulls the rotatable coupling of the second band towards the first buckle end.

15. The solar tracker of claim 11, wherein the strap includes a circular profile.

16. The solar tracker of claim 11, wherein the first connector and the second connector form a gap therebetween to permit a portion of the support beam to pass therethrough.

17. A method of coupling a solar module to a support beam, the method comprising:
attaching a rail to the support beam via a toolless fastening assembly, the toolless fastening assembly comprising:
a first strap portion having an elongate body and having a first connector,
a second strap portion having an elongate body and having a second connector, and
a boot buckle extending a buckle distance between a first buckle end and a second buckle end, the first buckle end being connectable to the first connector and the second buckle end being connectable to the second connector, the boot buckle having a latch lever, the latch lever rotatable between a first lever position and a second lever position, rotation of the latch lever from the first lever position to the second lever position shortening the buckle distance, whereby rotation of the latch lever from the first lever position to the second lever position, when the first buckle end is connected to the first connector and the second buckle end is connected to the second connector, pulls the first buckle end closer to the second buckle end to shorten the buckle distance; and
coupling the solar module to the rail.

18. The method of claim 17, wherein the boot buckle has a first band and a second band, the first band being rotatably coupled to the latch lever and extending towards the first buckle end, and the second band being rotatably coupled to the latch lever and extending towards the second buckle end.

19. The method of claim 18 further comprising, rotating the latch lever from the first lever position to the second lever position, wherein the rotation pulls the rotatable coupling of the first band towards the second buckle end, and pulls the rotatable coupling of the second band towards the first buckle end.

20. The method of claim 17 further comprising, aligning a dimple of the rail with a bore of the support beam such that the dimple is held within the bore when the latch lever is rotated from the first lever position to the second lever position.
